(19) United States
(12) Patent Application Publication
(10) Pub. No.: US 2009/0228873 A1
(43) Pub. Date: Sep. 10, 2009

(54) DISPLAY BREAKPOINTING BASED ON USER INTERFACE EVENTS

(76) Inventors: MAXWELL O. DRUKMAN, San Francisco, CA (US); Francois Jouaux, Woodside, CA (US); Steve Lewallen, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/397,267

(22) Filed: Mar. 3, 2009

Related U.S. Application Data
(60) Provisional application No. 61/033,756, filed on Mar. 4, 2008.

(51) Int. Cl. G06F 9/44

(52) U.S. Cl. 717/128; 717/129

(57) ABSTRACT

Techniques for monitoring breakpoints. An application having a breakpoint to be executed on a target device is received. The application is executed on the target device. A screen image corresponding to a display on the target device is captured in response to reaching the breakpoint while executing the application. The screen image is stored in a memory of the target device.

This U.S. patent application claims priority to U.S. Provisional Patent Application No. 61/033,756, entitled, “DISPLAY BREAKPOINTING BASED ON USER INTERFACE EVENTS” filed Mar. 4, 2008.

### BACKGROUND

1. Field

The present invention generally relates to testing of user interface (UI) interactions, and, more particularly, to debugging and optimizing software.

2. Description of Related Technology

Modern mobile devices such as media players and mobile phones generally utilize software in their operation. Errors or a lack of optimization in the software can cause negative device performance, for example causing the device to perform poorly, lock up, shut down, consume excess energy, or overheat. Software for mobile devices can be developed separately from the mobile device itself, for example in integrated development environments that can be linked to the mobile device. Software can be loaded onto mobile devices prior to purchase by an end user. Such software can generally be debugged by professional developers prior to release, but end users lack effective tools for debugging software that they might later develop for the mobile device.

End user software developers typically run an integrated development environment on a development computer. The development computer can be linked to the mobile device such that applications can be transferred between the development computer and the mobile device. Applications can only be modified on the development computer, but applications can only be executed on the mobile device. The development computer may also collect real-time information about the device through the link. Thus, end users attempting to debug an application normally operate the mobile device, for example by interacting with a user interface (UI), while collecting information on the development computer. Upon encountering an error in the application, the developer can look at the development computer to see whether the information can be indicative of the problem. However, applications generally operate too quickly for such a method to effectively allow a developer to determine if there are any errors in the application, and where those errors might occur. This may especially be true in the case of UI applications, which require developer attention and input. Thus, development of UI applications for mobile devices can be difficult due to the complexity of various scenarios.

### BRIEF DESCRIPTION OF THE DRAWINGS

These and other features, aspects, and advantages of the invention disclosed herein are described below with reference to the drawings of certain embodiments, which are intended to illustrate and not to limit the invention.

FIG. 1 illustrates an example embodiment of a system for interacting with a mobile device.

FIG. 2A illustrates an example embodiment of a graphical representation of information collected by a mobile device monitoring program.

FIG. 2B illustrates another example embodiment of a graphical representation of information collected by a mobile device monitoring program.

FIGS. 3A and 3B illustrate an example embodiment a method of reviewing messages.

FIG. 4 illustrates another system for interacting with a mobile device.

FIG. 5 illustrates an example embodiment of a method of debugging an application.

FIG. 6 illustrates another example embodiment of a method of debugging an application.

FIG. 7A illustrates an example embodiment of a mobile device.

FIG. 7B illustrates an example embodiment of a configurable top-level graphical user interface of a mobile device.

FIG. 8 is a block diagram of an example implementation of a mobile device.

### DETAILED DESCRIPTION

Systems and methods are provided for debugging an application for a mobile device by comparing information about the mobile device to messages created during executing the application on the mobile device. The application may be edited on a development computer executing an integrated development environment. In certain embodiments, editing the application may include creating instructions to create messages related to what is being displayed on the screen of the mobile device. The application instructions may be to capture the screen of the mobile device at one or more predefined moments during execution of the application, continuously over a portion of an application, or combinations thereof. Executing the application on the mobile device may include an operator interacting with a user interface. While executing the application, the development computer executing the integrated development environment can collect information about the mobile device in the form of messages. The messages may be transferred to the development computer executing the integrated development environment, where the messages may be compared to the information about the mobile device. In some embodiments, time stamps may be used to correlate the messages to the information. The integrated development environment may also emulate how a host computer might react when tethered to the mobile device.

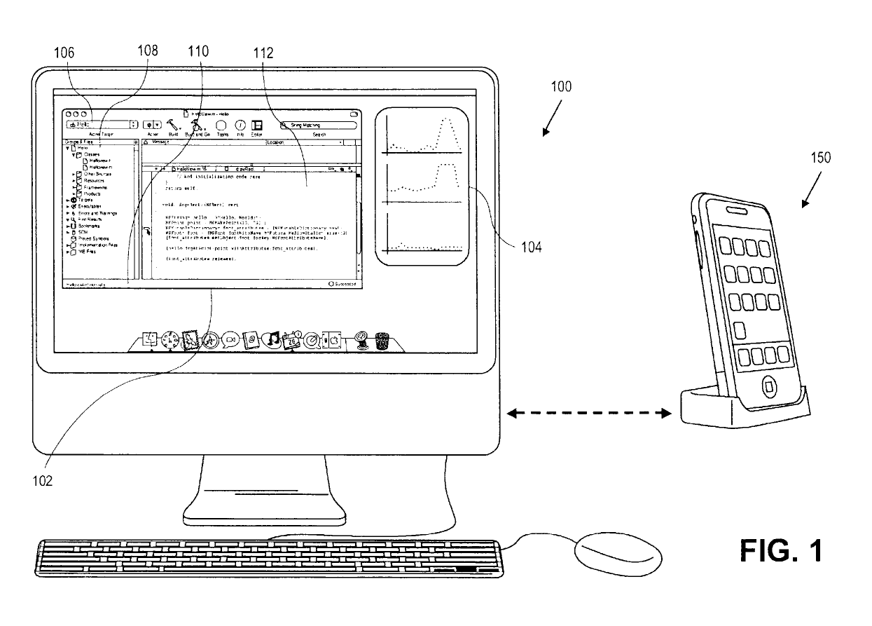

FIG. 1 illustrates development computer 100 that may be linked to mobile device 150 via tether, as indicated by the dashed arrows. As an example and without limitation, mobile device 150 may be an iPhone™, available from Apple, Inc. of Cupertino, Calif. In some embodiments, tether includes a physical wire such as a universal serial bus (USB). In some embodiments, tether includes a wireless connection such as a network or Bluetooth®. Development computer 100 may be executing or “running” an operating system. The operating system may be a platform for executing applications such as integrated development environment 102 and mobile device monitoring program 104. Integrated development environment 102 may include toolbar 106, list of files or groups of files 108, status bar 110, and detailed view screen 112. Additional, fewer, and rearranged areas are also possible. Detailed view screen 112 may change depending on, for example, the file being viewed or the tool being used. As an example and without limitation, integrated development environment 102 may be Xcode®, also available from Apple, Inc.

Mobile device monitoring program 104 may be configured to collect information regarding parameters of mobile device 150. For example and without limitation, parameters that can be monitored include: load on a central processing unit (CPU), load on system memory, load on a graphics card, drive access frequency, drive access time, a log of searches, local area network packets sent and/or received, cellular network packets sent and/or received, network detection, graphics throughput, memory leakage, and power usage. As an example and without limitation, mobile device monitoring program 104 may be Instruments, available from Apple, Inc., as well. Mobile device monitoring program 104 may be part of integrated development environment 102. Illustrated mobile device monitoring program 104 displays three monitored parameters at a time, although other parameters may also be being monitored but not displayed. As described above, upon operation of mobile device 150, parameters of mobile device 150 monitored by mobile device monitoring program 104 may change, for example resulting in data that may be used to construct line graphs such as depicted, but observing such changes can be burdensome or impossible for a developer operating mobile device 150. Thus, the event that caused the surges in the top two graphs may be unknown and difficult to reproduce so as to identify and reduce the surges. Reducing (e.g., mitigating or eliminating) surges in certain parameters can advantageous improve performance of mobile device 150.

Certain embodiments of the present invention allow a developer to interact with mobile device 150 without observing mobile device monitoring program 104. In some embodiments, the code may be instrumented with breakpoints that create a message at a predefined point in the application or program. In certain such embodiments, the message may include a captured image of what is displayed on the screen of mobile device 150. For example and without limitation, immediately before, during, or after a certain command, line of code, calculation, search, decision, user input, etc., the application may be configured to capture what is displayed on the screen of mobile device 150 or a portion of the screen of mobile device 150. Other examples of messages include anything that mobile device 150 can be configured to capture, such as, without limitation, memory usage, network load, applications being executed, and the like. Combinations of captured information within messages are also possible. The message may be time-stamped or otherwise tracked to an event to which the message corresponds. In some embodiments, the message may be stored in memory of mobile device 150. In certain such embodiments, the message can be transferred from mobile device 150 to development computer 100, whereupon the message may be compared to information gathered by mobile device monitoring program 104, which may be also time-stamped or otherwise tracked. In some embodiments, the message may be immediately transferred from mobile device 150 to development computer 100. In some embodiments, the message may be transferred from mobile device 150 to development computer 100 while executing an application based on a command sent from integrated development environment 102 or mobile device monitoring program 104. The message may be synchronized with information gathered about mobile device 150 by mobile device monitoring program 104. In some embodiments, the code may be instrumented with a plurality of breakpoints, for example to provide a more detailed representation of operation of the application on mobile device 150. Continuous message creation and combinations of continuous and individual message creation are also possible.

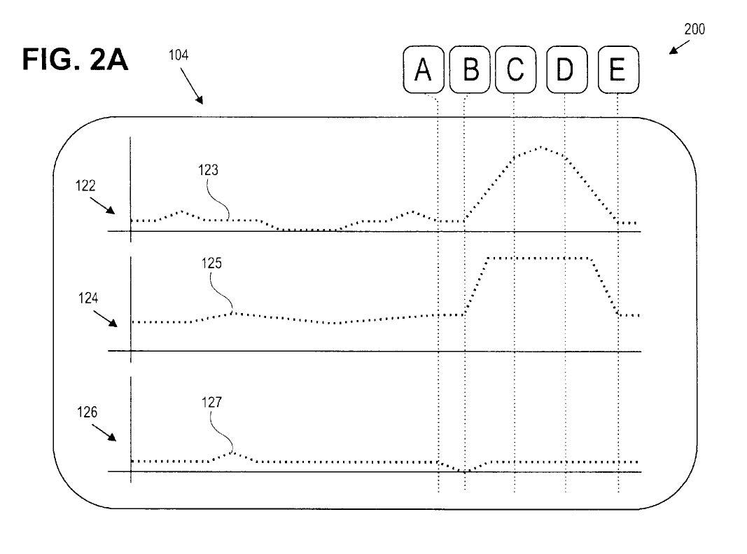

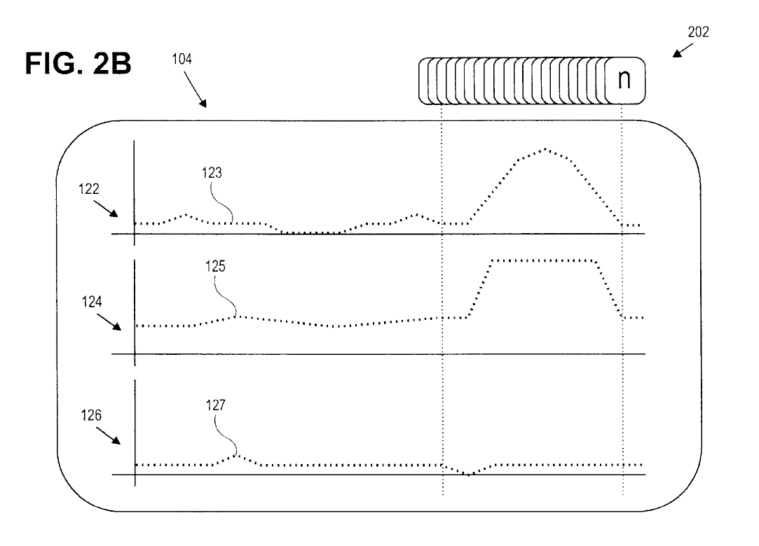

FIG. 2A illustrates an example embodiment of a graphical representation of information collected by mobile device monitoring program 104 to tie certain events to certain mobile device performance indicators. Graph 122 monitors a first parameter, graph 124 monitors a second parameter, and graph 126 monitors a third parameter. Data may be collected relatively continuously, as indicated by lines 123, 125, 127 in graphs 122, 124, 126, respectively. Graphs 122, 124, 126 may be depicted in any suitable format (e.g., line chart, bar chart, integrated line chart, x-y chart, etc.), and the format may be changed within mobile device monitoring program 104. The example code includes instructions to create a message (e.g., to capture the screen image of mobile device 150) at five points during execution of the application, indicated by the vertical dotted lines. The five screen captures of mobile device 150 correspond to images 200. The image of the first event may be represented by screen A of mobile device 150, the image of the second event may be represented by screen B of mobile device 150, the image of the third event may be represented by screen C of mobile device 150, the image of the fourth event may be represented by screen D of mobile device 150, and the image of the fifth event may be represented by screen E of mobile device 150. Images 200 may be used to characterize the effect of each event, for example to aid in determining which operation of the application caused changes in the parameters in graphs 122, 124.

FIG. 2B illustrates another example embodiment of a graphical representation of information collected by mobile device monitoring program 104 to tie certain events to certain mobile device performance indicators. In this embodiment, the example code includes instructions to create a message (e.g., to capture the screen image of mobile device 150) substantially continuously from a first event to a second event, indicated by the vertical dotted lines. The substantially continuous screen captures of mobile device 150 correspond to images 202 (e.g., to a variable n). Images 202 may be used to characterize the effect of each event, for example to determine which operation of the application caused changes in the parameters in graphs 122, 124. A skilled artisan will understand that there may be a balance between the type and quantity of messages created and the use of resources of mobile device 150 to create and store those messages.

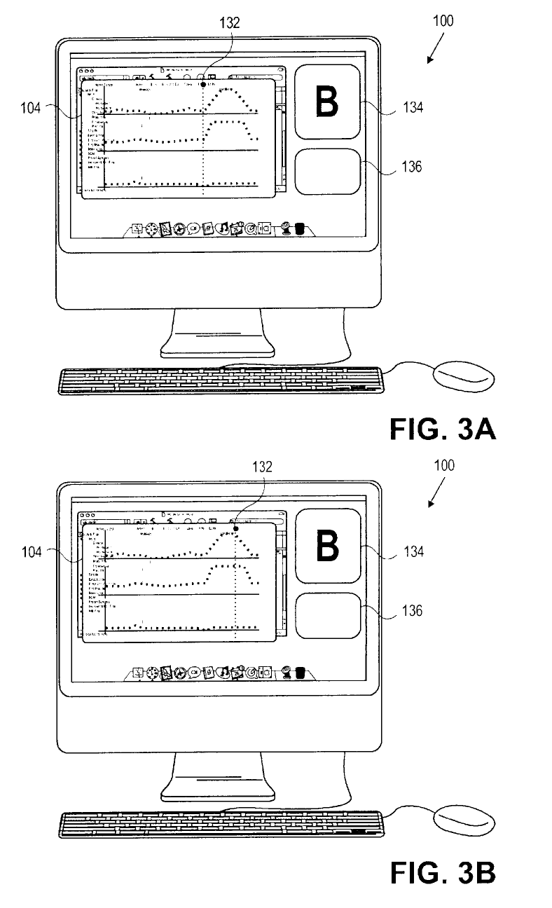

FIGS. 3A and 3B illustrate example embodiments of display screens during review of the messages, for example messages created by the method described with respect to FIG. 2A. For illustration purposes, the window of mobile device monitoring program 104 has been expanded, although integrated development environment 102 may still be running. In a review mode, bar 132 may be formed over the line graphs. As the developer moves bar 132, for example using a mouse or a keyboard, integrated development environment 102 may show one or more of images 200 in image area 134 that corresponds to the time indicated by bar 132. Bar 132 may also be a “mouse-over” or other appropriate means for directing attention to a particular point in time. If an event during execution of an application causes a change in a monitored parameter, for example, the code of the application proximate to that event may be analyzed to try to figure out how to reduce the change in the parameter.

As depicted in FIG. 2A, the example parameters monitored by graphs 122, 124 increased dramatically after the second event, and decreased to normal levels after the fifth event. Image B may be used to determine which operation of the application caused such a large increase in the parameters in graphs 122, 124, and image D may be used to determine which operation of the application caused such the decrease in the parameters in graphs 122, 124. Images A, C, and E may be used to identify events that do not cause a change or a significant change in the monitored parameters. When bar 132 is over the time of the second event, which is when two of the monitored parameters increased, screen capture B may be presented. When bar 132 is over the time of the fourth event, which is when the uppermost monitored parameter began to decrease, screen capture D may be presented. Additional information regarding those events or points in time may be presented in information area 136. In some embodiments, image area 134 may manipulated, for example by scrolling through images 200 using arrows, mouse clicks, a trackball, etc., which may cause a corresponding shift in bar 132. Detail area 136 may provide information about the code such that the developer is spared from needing to switch back and forth between mobile device monitoring program 104 and integrated development environment 102.

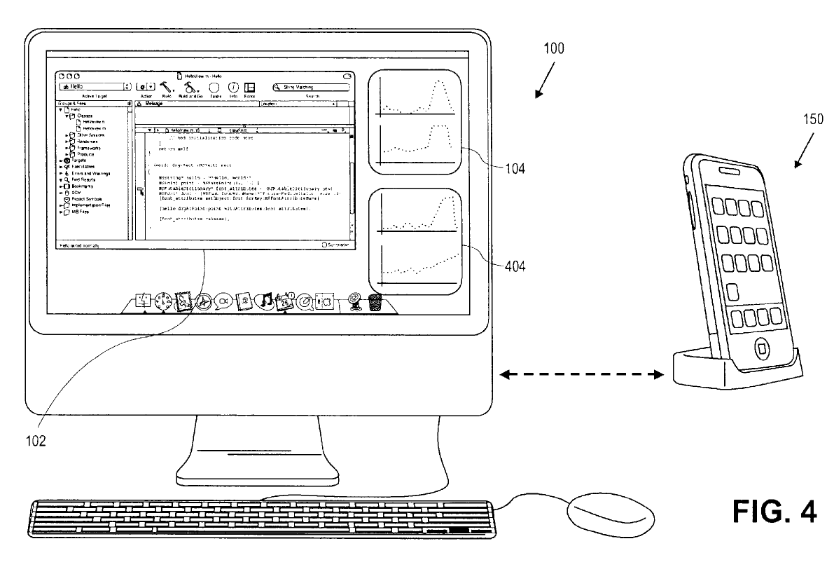

FIG. 4 illustrates development computer 100 executing host computer emulation program 404 while tethered to mobile device 150. When mobile device 150 interacts with host computer, for example to exchange files, to synchronize data, and the like, the transfer of data may have an effect on one or both of mobile device 150 and host computer. Host computer emulation program 404 may help a developer to measure the effects of certain applications on system parameters of mobile device 150 and/or emulated host computer. In some embodiments, the portion of the code of an application that allows mobile device 150 to interact with host computer may be instrumented with one or more breakpoints that create a message pertaining to mobile device 150 (e.g., a capture of the screen of mobile device 150) at one or more predefined points in the application, as described above. The message man be transferred from mobile device 150 to development computer 100, whereupon the message may be compared to information gathered by mobile device monitoring program 104 and/or host computer emulation program 404, which may also be time-stamped or otherwise tracked.

In certain embodiments in which multiple devices are being monitored or emulated, multiple parameters for each device are being monitored, and/or multiple applications are being executed on each device, the parameter being displayed in a particular graph may not be apparent. Accordingly, the following hierarchy may be used as an identifier of the displayed parameter, for example as labels on the graph, upon mouse-over, and the like: Device (e.g., mobile device 150 or host computer); Parameter (e.g., load on CPU or load on system memory); Process (e.g., application being executed). As an example, a graph may quickly be identified as CPU load on mobile device 150 while opening a media file.

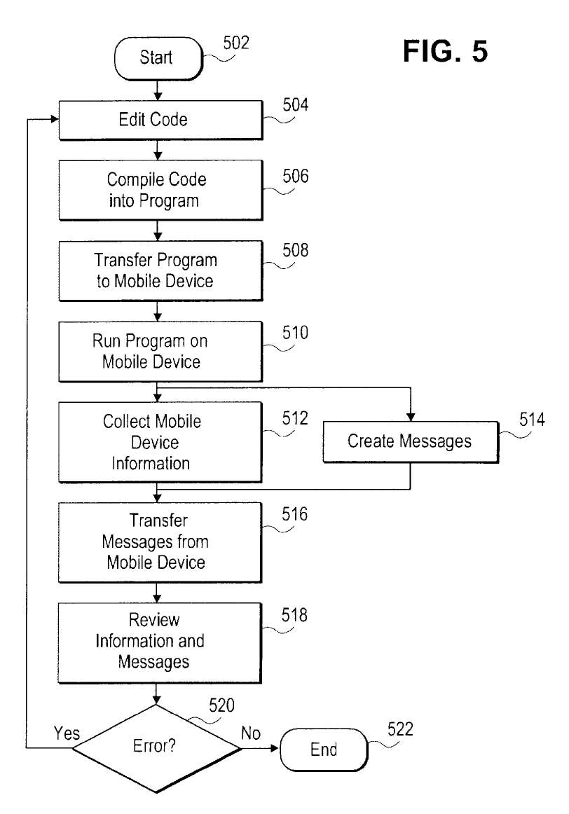

FIG. 5 illustrates an example embodiment of a method of debugging an application. Although described in terms of “debugging,” error correction, and the like, skilled artisans will appreciate that embodiments described herein may also be suitable for optimizing performance of certain applications. Referring to FIG. 5, the method begins at box 502, labeled “Start.” In box 504, code (e.g., source code) of an application may be edited. As described above, during editing, one or more breakpoints may be inserted into the code, for example at portions of the code that the programmer suspect may contain errors or that may not be optimized. Continuing to box 506, after the code has been edited to incorporate the breakpoint, the code may be compiled into an executable application. In box 508, the executable application may be transferred to mobile device 150. While still tethered to development computer 100, the application may be executed on mobile device 150, as indicated by box 510. While executing the application on mobile device 150, mobile device monitoring program 104 may collect information about mobile device 150 via tether, as described above. Additionally, the application may cause mobile device 150 to create messages upon the occurrence of certain events. In some embodiments, the events may include user interaction with a user interface, for example, pushing buttons to cause certain episodes to transpire. Messages created in box 514 may then be transferred from mobile device 150 to development computer 100 in box 516. After transfer of messages from mobile device 150 to development computer 100, development computer 100 may contain both messages created in box 514 and information collected in box 512. In box 518, the programmer of the code may review information collected from mobile device 150 in box 512 and messages created by mobile device 150 in box 514, for example as described above with respect to FIGS. 3A and 3B, for example to determine whether or not there was an error during execution of the application on mobile device 150. In decision box 520, if there was an error, the programmer may return to box 504 to re-edit the code of the application. In editing the code, the programmer may further instrument the code to create additional messages to better identify the source of an error, may remove message creation where no errors occur, and may modify portions of the code where the message indicates that there may be a problem to attempt to correct the issue. If there was not an error, the programmer may end the process, as indicated by box 522, labeled “End.”

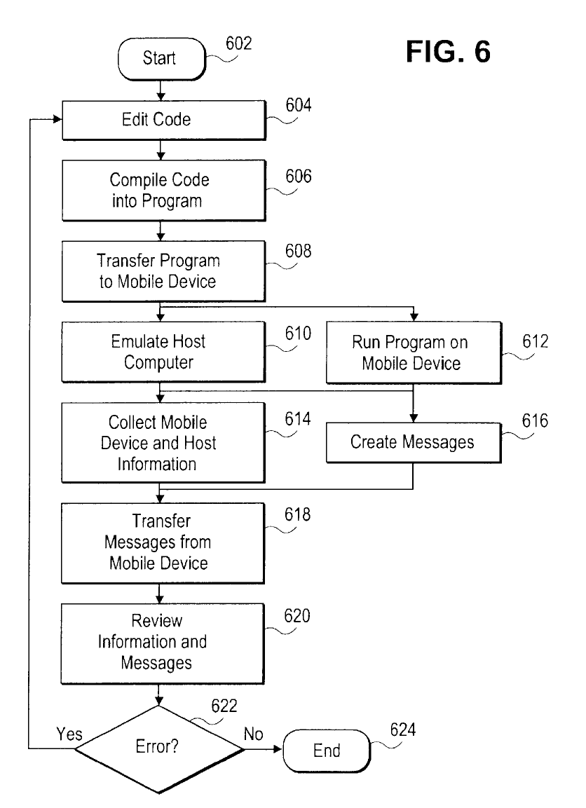

FIG. 6 illustrates another example embodiment of a method of debugging an application, for example with respect to interaction between mobile device 150 and host computer. The method begins at box 602, labeled “Start.” In box 604, code of an application may be edited. During editing, one or more breakpoints may be inserted into the code. Continuing to box 606, after the code has been edited to incorporate the breakpoint, the code may be compiled into an executable application. In box 608, the executable application may be transferred to mobile device 150. While still tethered to development computer 100, the application may be executed on mobile device 150, as indicated by box 612. While executing the application on mobile device 150, host computer emulation program 404 may mimic the response of host computer to interaction with mobile device 150, as indicated by box 610. In box 614, mobile device monitoring program 104 may collect information about mobile device 150 via tether during execution of the application on mobile device 150 and/or host computer emulation program 404 may collect information about emulated host computer. The application may cause mobile device 150 to create messages when events corresponding to the breakpoints occur. Messages created in box 616 may then be transferred from mobile device 150 to development computer 100 in box 618. After transfer of messages from mobile device 150 de development computer 100, development computer 100 may contain both messages created by mobile device 150 in box 616 and information about mobile device 150 and/or emulated host computer collected in box 614. In box 620, the programmer of the code may review the data to investigate whether or not there was an error during execution of the application on mobile device 150. In decision box 622, if there was an error, the programmer may return to box 604 to re-edit the code of the application. In editing the code, the programmer may further instrument the code to create additional messages to better identify the source of an error, may remove message creation where no errors occur, and may modify portions of the code where the message indicates that there may be a problem to attempt to correct the issue. The programmer may also edit the code of an application for a host computer that was emulated starting at box 610. If there was not an error, the programmer may end the process, as indicated by box 624, labeled “End.”

In certain embodiments, rather than instrumenting the code to create messages upon the occurrence of certain events, an exception handler may be integrated with integrated development environment 104. The exception handler automatically may create messages such as screen captures of mobile device 150 when a characteristic tracked by mobile device monitoring program 104 exceeds a certain boundary. Such embodiments may advantageously avoid frequent compilation and transferring of codes and applications.

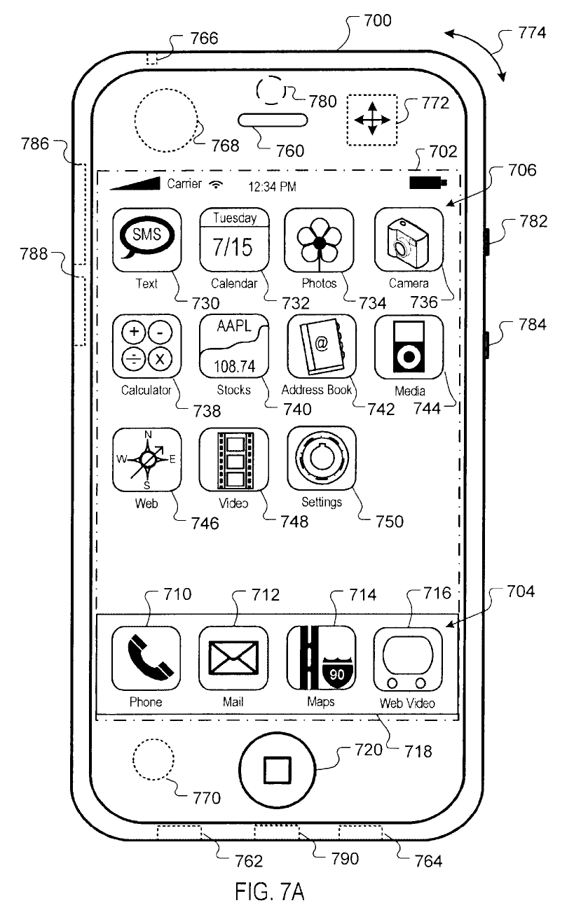

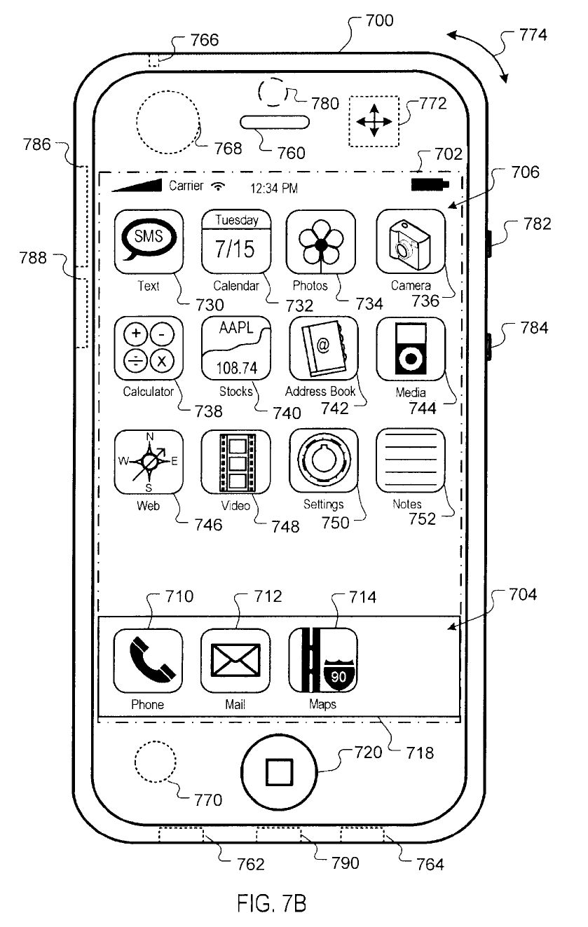

FIG. 7A illustrates an example mobile device 700. Mobile device 700 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, mobile device 700 includes touch-sensitive display 702. Touch-sensitive display 702 can be implemented with liquid crystal display (LCD) technology, light emitting polymer display (LPD) technology, or some other display technology. Touch-sensitive display 702 can be sensitive to haptic and/or tactile contact with a user.

In some implementations, touch-sensitive display 702 can include multi-touch-sensitive display 702. Multi-touch-sensitive display 702 can, for example, process multiple simultaneous touch points, including processing data related to the pressure, degree, and/or position of each touch point. Such processing may facilitate gestures and interactions with multiple fingers, chording, and other interactions. Other touch-sensitive display technologies can also be used (e.g., a display in which contact is made using a stylus or other pointing device). Some examples of multi-touch-sensitive display technology are described in U.S. Pat. Nos. 6,323,846, 6,570,557, 6,677,932, and 6,888,536, each of which is incorporated by reference herein in its entirety.

In some implementations, mobile device 700 can display one or more graphical user interfaces on touch-sensitive display 702 for providing the user access to various system objects and for conveying information to the user. In some implementations, the graphical user interface can include one or more display objects 704, 706. In the example shown, display objects 704, 706 are graphic representations of system objects. Some examples of system objects include device functions, applications, windows, files, alerts, events, or other identifiable system objects.

In some implementations, mobile device 700 can implement multiple device functionalities, such as a telephony device, as indicated by Phone object 710; an e-mail device, as indicated by Mail object 712; a map device, as indicated by Maps object 714; a Wi-Fi base station device (not shown); and a network video transmission and display device, as indicated by Web Video object 716. In some implementations, particular display objects 704 (e.g., Phone object 710, Mail object 712, Maps object 714, and Web Video object 716) can be displayed in menu bar 718. In some implementations, device functionalities can be accessed from a top-level graphical user interface, such as the graphical user interface illustrated in FIG. 7A. Touching one of objects 710, 712, 714, or 716 can, for example, invoke a corresponding functionality.

In some implementations, mobile device 700 can implement a network distribution functionality. For example, the functionality can enable the user to take mobile device 700 and provide access to its associated network while traveling. In particular, mobile device 700 can extend Internet access (e.g., Wi-Fi) to other wireless devices in the vicinity. For example, mobile device 700 can be configured as a base station for one or more devices. As such, mobile device 700 can grant or deny network access to other wireless devices.

In some implementations, upon invocation of a device functionality, the graphical user interface of mobile device 700 can change, or can be augmented or replaced with another user interface or user interface elements to facilitate user access to particular functions associated with the corresponding device functionality. For example, in response to a user touching Phone object 710, the graphical user interface of touch-sensitive display 702 may present display objects related to various phone functions. Likewise, touching of Mail object 712 may cause the graphical user interface to present display objects related to various e-mail functions, touching Maps object 714 may cause the graphical user interface to present display objects related to various maps functions, and touching Web Video object 716 may cause the graphical user interface to present display objects related to various web video functions.

In some implementations, the top-level graphical user interface environment or state of FIG. 7A can be restored by pressing button 720 located near the bottom of mobile device 700. In some implementations, each corresponding device functionality may have corresponding “home” display objects displayed on touch-sensitive display 702, and the graphical user interface environment of FIG. 7A can be restored by pressing the “home” display object.

In some implementations, the top-level graphical user interface can include additional display objects 706, such as short messaging service (SMS) object 730, Calendar object 732, Photos object 734, Camera object 736, Calculator object 738, Stocks object 740, Address Book object 742, Media object 744, Web object 746, Video object 748, Settings object 750, and Notes object (not shown). Touching SMS display object 730 can, for example, invoke an SMS messaging environment and supporting functionality; likewise, each selection of display object 732, 734, 736, 738, 740, 742, 744, 746, 748, 750 can invoke a corresponding object environment and functionality.

Additional and/or different display objects can also be displayed in the graphical user interface of FIG. 7A. For example, if mobile device 700 is functioning as a base station for other devices, one or more “connection” objects may appear in the graphical user interface to indicate the connection. In some implementations, display objects 706 can be configured by a user, e.g., a user may specify which display objects 706 are displayed, and/or may download additional applications or other software that provides other functionalities and corresponding display objects.

In some implementations, mobile device 700 can include one or more input/output (I/O) devices and/or sensor devices. For example, speaker 760 and microphone 762 can be included to facilitate voice-enabled functionalities, such as phone and voice mail functions. In some implementations, up/down button 784 for volume control of speaker 760 and microphone 762 can be included. Mobile device 700 can also include on/off button 782 for a ring indicator of incoming phone calls. In some implementations, loud speaker 764 can be included to facilitate hands-free voice functionalities, such as speaker phone functions. Audio jack 766 can also be included for use of headphones and/or a microphone.

In some implementations, proximity sensor 768 can be included to facilitate the detection of the user positioning mobile device 700 proximate to the user's ear and, in response, to disengage touch-sensitive display 702 to prevent accidental function invocations. In some implementations, touch-sensitive display 702 can be turned off to conserve additional power when mobile device 700 is proximate to the user's ear.

Other sensors can also be used. For example, in some implementations, ambient light sensor 770 can be utilized to facilitate adjusting brightness of touch-sensitive display 702. In some implementations, accelerometer 772 can be utilized to detect movement of mobile device 700, as indicated by directional arrow 774. Accordingly, display objects and/or media can be presented according to a detected orientation (e.g., portrait or landscape). In some implementations, mobile device 700 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into mobile device 700 or provided as a separate device that can be coupled to mobile device 700 through an interface (e.g., port device 790) to provide access to location-based services.

In some implementations, port device 790 (e.g., a Universal Serial Bus (USB) port, or a docking port, or some other wired port connection) can be included. Port device 790 can, for example, be utilized to establish a wired connection to other computing devices, such as other mobile devices 700, network access devices, a personal computer, a printer, a display screen, or other processing devices capable of receiving and/or transmitting data. In some implementations, port device 790 allows mobile device 700 to synchronize with a host device using one or more protocols, such as, for example, the TCP/IP, HTTP, UDP and any other known protocol.

Mobile device 700 can also include camera lens and sensor 780. In some implementations, camera lens and sensor 780 can be located on the back surface of mobile device 700. The camera can capture still images and/or video.

Mobile device 700 can also include one or more wireless communication subsystems, such as 802.11b/g communication device 786, and/or Bluetooth™ communication device 788. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

FIG. 7B illustrates another example of configurable top-level graphical user interface of mobile device 700. Mobile device 700 can be configured to display a different set of display objects.

In some implementations, each of one or more system objects of mobile device 700 has a set of system object attributes associated with it; and one of the attributes determines whether a display object for the system object will be rendered in the top-level graphical user interface. This attribute can be set by the system automatically, or by a user through certain programs or system functionalities as described below. FIG. 7B shows an example of how Notes object 752 (not shown in FIG. 7A) is added to, and Web Video object 716 is removed from, the top graphical user interface of mobile device 700 (e.g., such as when the attributes of the Notes system object and the Web Video system object are modified).

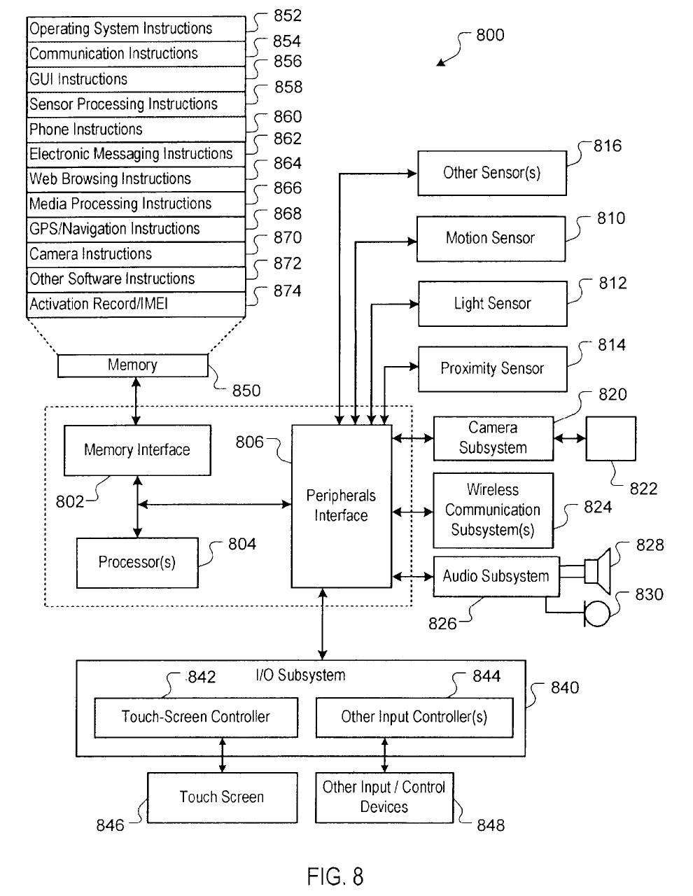

FIG. 8 is a block diagram 800 of an example implementation of a mobile device (e.g., mobile device 700). The mobile device can include memory interface 802, one or more data processors, image processors and/or central processing units 804, and peripherals interface 806. Memory interface 802, one or more processors 804 and/or peripherals interface 806 can be separate components or can be integrated in one or more integrated circuits. The various components in the mobile device can be coupled by one or more communication buses or signal lines.

Sensors, devices, and subsystems can be coupled to peripherals interface 806 to facilitate multiple functionalities. For example, motion sensor 810, light sensor 812, and proximity sensor 814 can be coupled to peripherals interface 806 to facilitate the orientation, lighting, and proximity functions described with respect to FIG. 7A. Other sensors 816 can also be connected to peripherals interface 806, such as a positioning system (e.g., GPS receiver), a temperature sensor, a biometric sensor, or other sensing device, to facilitate related functionalities.

Camera subsystem 820 and optical sensor 822 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 824, which can include radio frequency receivers and transmitters and/or optical (e.g., infrared) receivers and transmitters. The specific design and implementation of communication subsystem 824 can depend on the communication network(s) over which the mobile device is intended to operate. For example, a mobile device can include communication subsystems 824 designed to operate over a GSM network, a GPRS network, an EDGE network, a Wi-Fi or WiMax network, and a Bluetooth™ network. In particular, wireless communication subsystems 824 may include hosting protocols such that the mobile device may be configured as a base station for other wireless devices.

Audio subsystem 826 can be coupled to speaker 828 and microphone 830 to facilitate voice-enabled functions, such as voice recognition, voice replication, digital recording, and telephony functions.

I/O subsystem 840 can include touch screen controller 842 and/or other input controller(s) 844. Touch-screen controller 842 can be coupled to touch screen 846. Touch screen 846 and touch screen controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 846.

Other input controller(s) 3044 can be coupled to other input/control devices 848, such as one or more buttons, rocker switches, thumb-wheel, infrared port, USB port, and/or a pointer device such as a stylus. The one or more buttons (not shown) can include an up/down button for volume control of speaker 828 and/or microphone 830.

In one implementation, a pressing of the button for a first duration may disengage a lock of touch screen 846, and a pressing of the button for a second duration that is longer than the first duration may turn power to the mobile device on or off. The user may be able to customize a functionality of one or more of the buttons. Touch screen 846 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

Memory interface 802 can be coupled to memory 850. Memory 850 can include high-speed random access memory and/or non-volatile memory, such as one or more magnetic disk storage devices, one or more optical storage devices, and/or flash memory (e.g., NAND, NOR). Memory 850 can store operating system 852, such as Darwin, RTXC, LINUX, UNIX, OS X, WINDOWS, or an embedded operating system such as VxWorks. Operating system 852 may include instructions for handling basic system services and for performing hardware dependent tasks. In some implementations, operating system 852 can be a kernel (e.g., UNIX kernel).

Memory 850 may also store communication instructions 854 to facilitate communicating with one or more additional devices, one or more computers and/or one or more servers. Memory 850 may include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GPS/Navigation instructions 868 to facilitate GPS and navigation-related processes and instructions; camera instructions 870 to facilitate camera-related processes and functions; and/or other software instructions 872 to facilitate other processes and functions (e.g., access control management functions). Memory 850 may also store other software instructions (not shown), such as web video instructions to facilitate web video-related processes and functions and/or web shopping instructions to facilitate web shopping-related processes and functions. In some implementations, media processing instructions 866 may be divided into audio processing instructions and video processing instructions, for example to facilitate audio processing-related processes and functions and video processing-related processes and functions, respectively. Activation record and International Mobile Equipment Identity (IMEI) 874 or similar hardware identifier can also be stored in memory 850.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. For example, certain applications described herein may be combined, separated, and differently structured. Thus, it is intended that the scope of the present invention herein disclosed should not be limited by the particular disclosed embodiments described above.

What is claimed is:

1. A method comprising:
executing an application having a breakpoint on a target device;
capturing a screen image corresponding to a display on the target device in response to reaching the breakpoint while executing the application;
storing the screen image in a memory of the target device.

2. The method of claim 1 further comprising receiving the application to be executed on a target device from a host electronic device.

3. The method of claim 2 wherein the target device comprises a mobile electronic device.

4. The method of claim 1 wherein the target device comprises an electronic device on which the application is compiled.

5. The method of claim 1 wherein capturing a screen image corresponding to a display on the target device in response to reaching the breakpoint while executing the application comprises capturing the screen image corresponding to a time at which the breakpoint is reached.

6. The method of claim 1 wherein capturing a screen image corresponding to a display on the target device in response to reaching the breakpoint while executing the application comprises capturing the screen image corresponding to a preselected amount of time before the breakpoint is reached.

7. The method of claim 1 wherein capturing a screen image corresponding to a display on the target device in response to reaching the breakpoint while executing the application comprises capturing the screen image corresponding to a preselected amount of time after the breakpoint is reached.

8. The method of claim 1 further comprising providing the captured screen image to a host electronic device in response to the target device being tethered to the host electronic device.

9. An apparatus comprising:
means for receiving an application to be executed on a target device, the application having a breakpoint;
means for executing the application on the target device;
means for capturing a screen image corresponding to a display on the target device in response to reaching the breakpoint while executing the application;
means for storing the screen image in a memory of the target device.

10. The apparatus of claim 9 further comprising means for providing the captured screen image to a host electronic device in response to the target device being tethered to the host electronic device.

11. An electronic system comprising:
a memory to store an application having a breakpoint;
a processor coupled with the memory to execute the application, wherein when the processor reaches the breakpoint in execution of the application, the processor causes a screen image corresponding to a display on the electronic system to be captured and stored in the memory.

12. The electronic system of claim 11 further comprising an interface to couple the electronic system to a host device, wherein the application is received from the host device via the interface.

13. The system of claim 11 wherein the screen image comprises a current screen image corresponding to a time at which the breakpoint is reached.

14. The system of claim 11 wherein the screen image comprises a previous screen image corresponding to a preselected amount of time before a time at which the breakpoint is reached.

15. The system of claim 11 wherein the screen image comprises a subsequent screen image corresponding to a preselected amount of time after a time at which the breakpoint is reached.

16. An article comprising a computer-readable medium having stored thereon instructions that, when executed by one or more processors, cause the one or more processors to:
execute an application having a breakpoint on a target device;
capture a screen image corresponding to a display on the target device in response to reaching the breakpoint while executing the application;
store the screen image in a memory of the target device.

17. The article of claim 16 further comprising instructions that, when executed, cause the one or more processors to receive the application to be executed on a target device from a host electronic device.

18. The article of claim 17 wherein the target device comprises a mobile electronic device.

19. The article of claim 16 wherein the target device comprises an electronic device on which the application is compiled.

20. The article of claim 16 wherein capturing a screen image corresponding to a display on the target device in response to reaching the breakpoint while executing the application comprises capturing the screen image corresponding to a time at which the breakpoint is reached.

21. The article of claim 16 wherein capturing a screen image corresponding to a display on the target device in response to reaching the breakpoint while executing the application comprises capturing the screen image corresponding to a preselected amount of time before the breakpoint is reached.

22. The article of claim 16 wherein capturing a screen image corresponding to a display on the target device in response to reaching the breakpoint while executing the application comprises capturing the screen image corresponding to a preselected amount of time after the breakpoint is reached.

23. The article of claim 16 further comprising instructions that, when executed, cause the one or more processors to provide the captured screen image to the host electronic device via the interface in response to the target device being tethered to the host electronic device.
